(19) United States
(12) Patent Application Publication
(10) Pub. No.: US 2017/0115375 A1
(43) Pub. Date: Apr. 27, 2017

(54) WIRELESS DEVICE, DISTANCE ESTIMATION SYSTEM, POSITION ESTIMATION SYSTEM, DISTANCE ESTIMATION METHOD, POSITION ESTIMATION METHOD, DISTANCE-ESTIMATION-PROGRAM RECORDING MEDIUM, AND POSITION-ESTIMATION-PROGRAM RECORDING MEDIUM

(71) Applicant: NEC Corporation, Minato-ku, Tokyo (JP)

(72) Inventor: Hiroyuki IGURA, Tokyo (JP)

(73) Assignee: NEC Corporation, Minato-ku, Tokyo (JP)

(21) Appl. No.: 15/127,093

(22) PCT Filed: Feb. 27, 2015
(86) PCT No.: PCT/JP2015/001065

§ 371 Date: Sep. 19, 2016

(30) Foreign Application Priority Data
Mar. 28, 2014 (JP) 2014-068137

(51) Int. Cl. G01S 5/02; G01S 13/76

(52) U.S. Cl. CPC G01S 5/0289; G01S 13/76

(57) ABSTRACT

To precisely and rapidly estimate a distance and a relative positional relation between a plurality of wireless devices, a wireless device includes an RF-signal transmission means, an RF-signal reception means, a loopback path, and a control means. The control means includes a timing-pulse-signal transmission means, a timing-pulse-signal reception means, a delay-time reception means, and a distance estimation means. The loopback path loops back an RF signal transmitted from the RF-signal transmission means to the RF-signal reception means. When the wireless device transmits a first-timing-pulse signal and a second wireless device receives the signal, the second wireless device transmits a second-timing-pulse signal, triggered by the reception. The second wireless device further transmits a delay time between reception of the first-timing-pulse signal and transmission of the second-timing-pulse signal. The distance estimation means estimates a distance between the wireless devices, in accordance with the received first- and second-timing-pulse signals and the delay time.

### TECHNICAL FIELD

The present invention relates to a wireless device, a distance estimation system, a position estimation system, a distance estimation method, a position estimation method, a distance-estimation-program recording medium, and a position-estimation-program recording medium.

### BACKGROUND ART

When a plurality of wireless devices exist, there is a need for rapid grasp of a distance and a relative positional relation between wireless devices. Various technologies satisfying the need are disclosed.

For example, PTL 1 discloses a method using a radio field intensity. The radio field intensity is inversely proportional to a square of a distance, and therefore the distance can be estimated when the radio field intensity of the source is known. By use of the method, a relative positional relation can be estimated with three or more wireless devices.

Further, a relative positional relation can be obtained by grasping respective absolute positions. The most typical systems obtaining an absolute position include a global positioning system (GPS). However, the GPS requires time and a hardware resource for measurement. Accordingly, an assisted-GPS (A-GPS) providing assisting information from a base station is developed and is widely used in a mobile telephone service and the like. Additionally, in PTL 2, the A-GPS is combined with an observed time difference of arrival (OTDOA) utilizing an arrival time difference of radio waves from a plurality of base stations, and the like, for enhanced positioning precision.

### CITATION LIST

### Patent Literature

[PTL 1] Japanese Patent No. 3165391

[PTL 2] Japanese Translation of PCT International Application Publication No. 2013-534076

### SUMMARY OF INVENTION

### Technical Problem

However, the technology in PTL 1 has a problem that positional precision is low. The reason is that a radio field intensity is greatly influenced by an ambient environment.

Further, the method of measuring an absolute position, including PTL 2, has a problem that processing takes time. Although the A-GPS takes less time than the GPS, initial positioning takes time around several tens of seconds and an update takes time around several seconds. Furthermore, it is assumed in the systems that time is synchronized between base stations, and a mechanism for time synchronization and a precise clock are required. Further, in a common wireless device, a delay time unique to the wireless device exists in a transmission circuit and a reception circuit. Consequently, it is difficult to precisely measure a true propagation time when a radio wave propagates between devices. Then, an error in a measured propagation time causes an error in position estimation.

The present invention is made in view of the aforementioned problem, and an object thereof is to provide a method of precisely and rapidly estimating a relative position between a plurality of mobile objects.

### Solution to Problem

In order to solve the aforementioned problem, a wireless device according to the present invention includes an RF-signal transmission means for transmitting an RF signal, an RF-signal reception means for receiving an RF signal, an antenna transmitting and receiving the RF signal, a loopback path looping back an RF signal transmitted by the RF-signal transmission means to the RF-signal reception means, and a control means for exchanging a signal between the RF-signal transmission means and the RF-signal transmission means, and the control means includes a timing-pulse-signal transmission means for transmitting a timing pulse signal to the RF-signal transmission means, a timing-pulse-signal reception means for receiving a timing pulse signal from the RF-signal reception means, a delay-time reception means for receiving, from a second wireless device transmitting a second-timing-pulse signal triggered by reception of a first-timing-pulse signal transmitted by the local device as a first wireless device, a delay time between reception of the first-timing-pulse signal and transmission of the second-timing-pulse signal, respectively by the second wireless device, and a distance estimation means for estimating a distance between the local device and the second wireless device, in accordance with the first-timing-pulse signal, the second-timing-pulse signal, and the delay time.

### Advantageous Effects of Invention

An effect of the present invention is that a relative positional relation between a plurality of wireless devices can be obtained precisely and rapidly.

### BRIEF DESCRIPTION OF DRAWINGS

FIG. 1 is a block diagram illustrating a second exemplary embodiment.

FIG. 2 is a block diagram illustrating a third exemplary embodiment.

FIG. 3 is a block diagram illustrating a fourth exemplary embodiment.

FIG. 4 is a timing chart illustrating an operation according to the fourth exemplary embodiment.

FIG. 5 is a block diagram illustrating a fifth exemplary embodiment.

FIG. 6 is a diagram illustrating a positional relation between wireless devices according to the fifth exemplary embodiment.

FIG. 7 is a flowchart illustrating an overview of the fifth exemplary embodiment.

FIG. 8 is a diagram illustrating a signal transmission procedure according to the fifth exemplary embodiment.

FIG. 9 is a timing chart illustrating an operation according to the fifth exemplary embodiment.

FIG. 10 is a diagram illustrating an application example of the fifth exemplary embodiment.

FIG. 11 is a diagram illustrating another application example of the fifth exemplary embodiment.

FIG. 12 is a block diagram illustrating a sixth exemplary embodiment.

FIG. 13 is a block diagram illustrating a configuration example of a delay measurement circuit according to a seventh exemplary embodiment.

FIG. 14 is a graph illustrating an example of a power profile according to the seventh exemplary embodiment.

FIG. 15 is a block diagram illustrating a configuration example of a matched filter according to the seventh exemplary embodiment.

FIG. 16 is a block diagram illustrating a configuration example of a reception RF circuit according to the seventh exemplary embodiment.

FIG. 17 is a block diagram illustrating a configuration example of a transmission RF circuit according to the seventh exemplary embodiment.

FIG. 18 is a block diagram illustrating a first exemplary embodiment.

### DESCRIPTION OF EMBODIMENTS

The present invention will be described in detail below with reference to the drawings.

### First Exemplary Embodiment

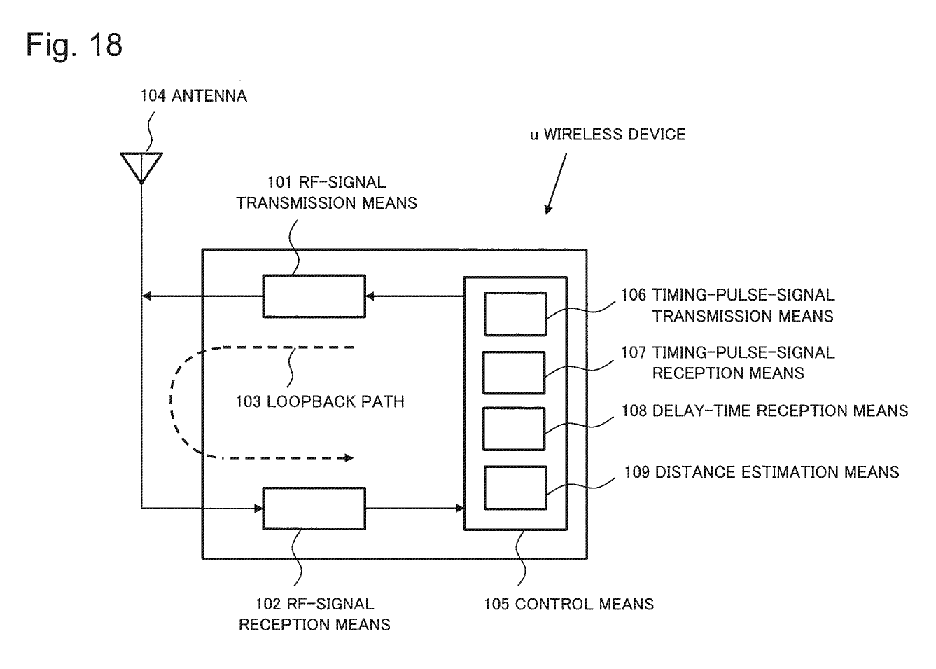

FIG. 18 is a block diagram illustrating a first exemplary embodiment of the present invention. A wireless device u includes a radio frequency (RF) signal transmission means 101, an RF-signal reception means 102, a loopback path 103, an antenna 104, and a control means 105. Additionally, the control means 105 includes a timing-pulse-signal transmission means 106, a timing-pulse-signal reception means 107, a delay-time reception means 108, and a distance estimation means 109.

The RF-signal transmission means 101 transmits a signal input from the control means 105 to the antenna 104 and the loopback path 103, as an RF signal.

The RF-signal reception means 102 receives an RF signal input from the antenna 104 and the loopback path 103, and outputs the signal to the control unit 105.

The loopback path 103 loops back an RF signal transmitted from the RF-signal transmission means 101, and inputs the signal to the RF-signal reception means 102.

The timing-pulse-signal transmission means 106 generates a timing pulse signal, and transmits the signal to the RF-signal transmission means 101.

The timing-pulse-signal reception means 107 receives a timing pulse signal transmitted from the RF-signal reception means 102.

The timing-pulse-signal reception means 107 receives two types of timing pulse signals. One is a first-timing-pulse signal transmitted and looped back by the local device. The other is a second-timing-pulse signal transmitted from a second wireless device positioned at a location different from the local device. A second-timing-pulse signal is transmitted by the second wireless device, triggered by reception of a first-timing-pulse signal.

The delay-time reception means 109 receives a delay time between reception of a first-timing-pulse signal and transmission of a second-timing-pulse signal, respectively by the second wireless device, as information.

The distance estimation means 110 estimates a distance from the wireless device u to the second wireless device. The estimation is performed in accordance with a first-timing-pulse signal, a second-timing-pulse signal, and a delay time, respectively received by the control means 105.

With the aforementioned configuration, the wireless device u is able to precisely and rapidly estimate a distance to the second wireless device. The reason is that a delay time for transmission and reception generated in the wireless device is offset, and a propagation time of a radio wave from the wireless device u to the second wireless device can be precisely obtained.

### Second Exemplary Embodiment

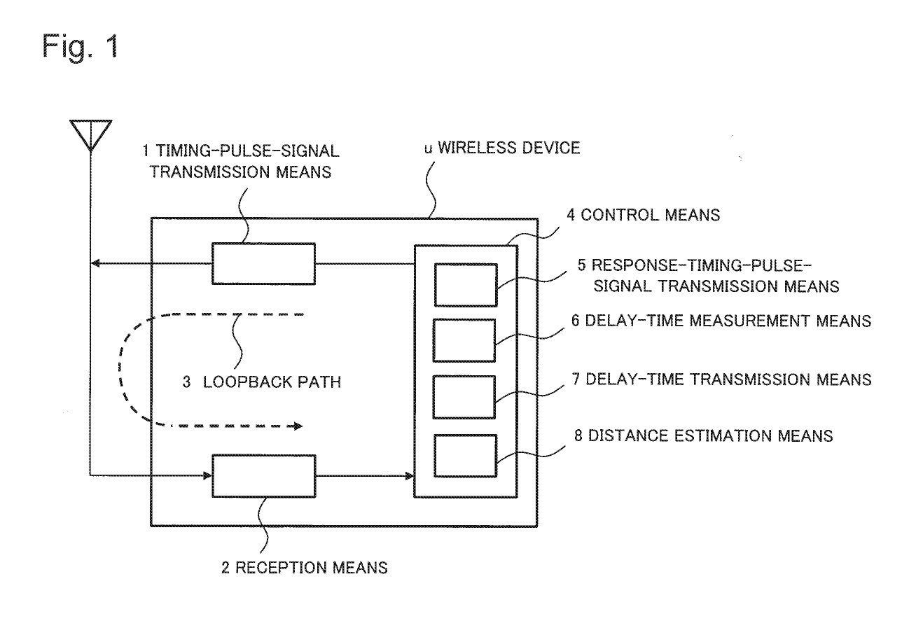

FIG. 1 is a block diagram illustrating a second exemplary embodiment of the present invention. A wireless device u according to the present exemplary embodiment includes a timing-pulse-signal transmission means 1, a reception means 2, a loopback path 3, and a control means 4. Additionally, the control means 4 includes a response-timing-pulse-signal transmission means 5, a delay-time measurement means 6, a delay-time transmission means 7, and a distance estimation means 8.

The timing-pulse-signal transmission means 1 transmits a first-timing-pulse signal, as the local device being a first wireless device. The loopback path 3 loops back a first-timing-pulse signal to the reception means 2. The reception means 2 receives an external signal and a first-timing-pulse signal input from the loopback path 3.

The control means 4 has a function of controlling respective units in the wireless device u, and estimating a distance to a second wireless device positioned at a location different from the local device, by use of a signal received by the reception means 2.

When the reception means 2 receives a timing pulse signal transmitted to the local device, the response-timing-pulse-signal transmission means 5 transmits a response-timing-pulse signal.

The delay-time measurement means 6 measures a delay time between reception of a timing pulse signal addressed to the local device, and transmission of a response-timing-pulse signal.

The delay-time transmission means 7 transmits a delay time measured by the delay-time measurement means 6 to the second wireless device being an estimation target.

By use of at least two of the wireless devices u in the aforementioned configuration, a mutual distance can be estimated, in accordance with a first-timing-pulse signal transmission time, a response-timing-pulse signal reception time, and a delay time. Details of the distance estimation operation will be described in a fourth exemplary embodiment.

### Third Exemplary Embodiment

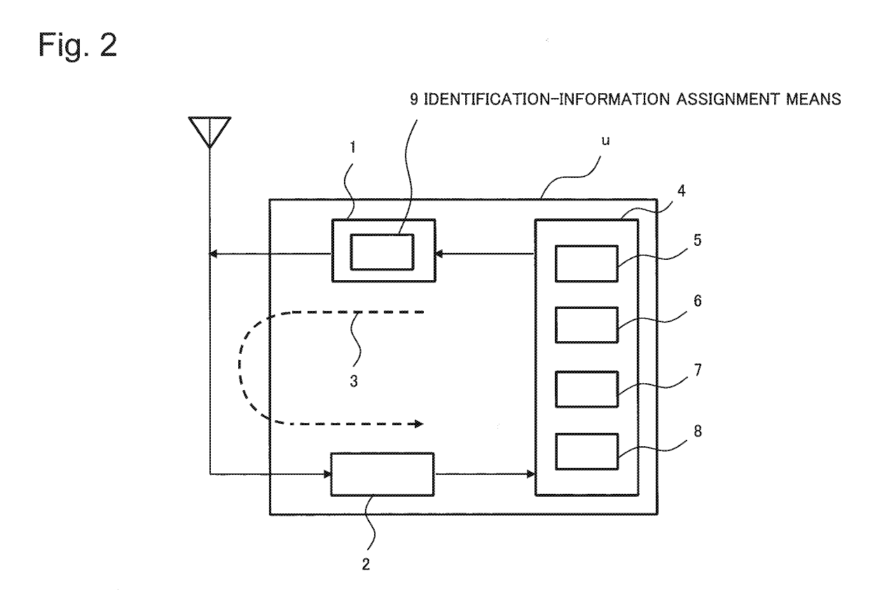

FIG. 2 is a block diagram illustrating a third exemplary embodiment of the present invention. A wireless device u according to the present exemplary embodiment includes an identification-information assignment means 9 for assigning identification information to a timing pulse signal. The identification information is information for distinguishing a first-timing-pulse signal from a response-timing-pulse signal. While the identification information may take any form, when, for example, spread spectrum communication is performed, a method in which the signals are encoded with different spread codes may be employed. While the identification-information assignment means 9 is provided in a timing-pulse-signal transmission means 1 in FIG. 2, the means may be provided in a control means 4 or a response-timing-pulse-signal transmission means 5.

### Fourth Exemplary Embodiment

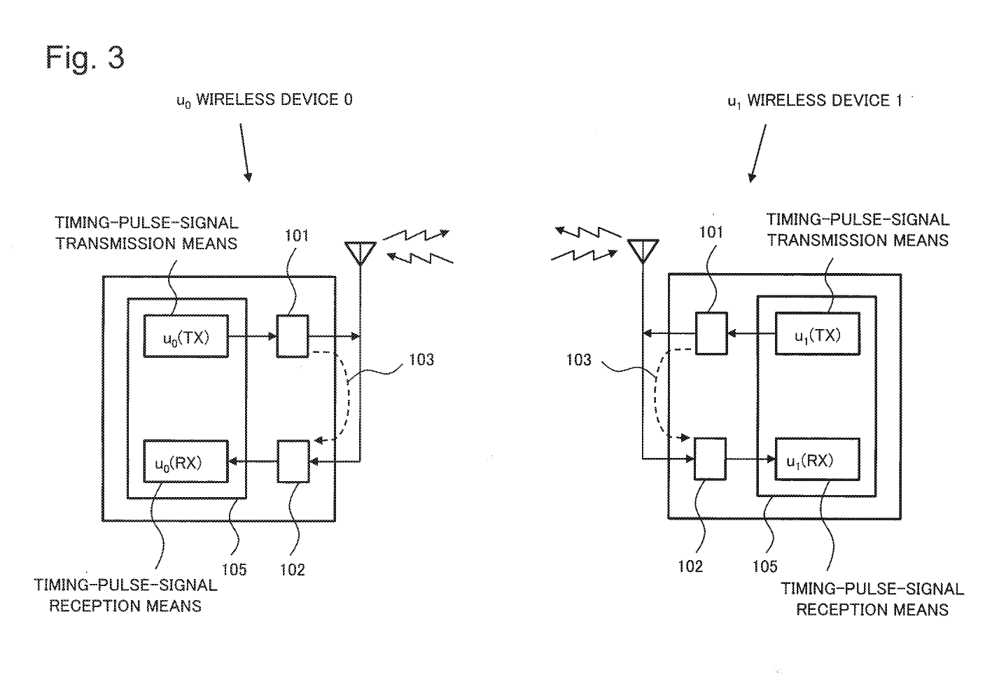

FIG. 3 is a block diagram illustrating a fourth exemplary embodiment of the present invention. The present exemplary embodiment is a distance estimation system using two of the wireless devices u according to the first exemplary embodiment. A wireless device 0u₀ and a wireless device 1u₁ are positioned at distant locations. With this configuration, a distance can be precisely estimated by mutually transmitting and receiving a timing pulse signal. For description of an operation according to the present exemplary embodiment, a timing-pulse-signal transmission means is denoted by u(TX), a timing-pulse-signal reception means is denoted by u(RX). Accordingly, in FIG. 3, the timing-pulse-signal transmission means and the reception means in the wireless device 0u₀ are respectively denoted by u₀(TX) and u₀(RX). Further, the timing-pulse-signal transmission means and the reception means in the wireless device 1u₁ are respectively denoted by u₁(TX) and u₁(RX).

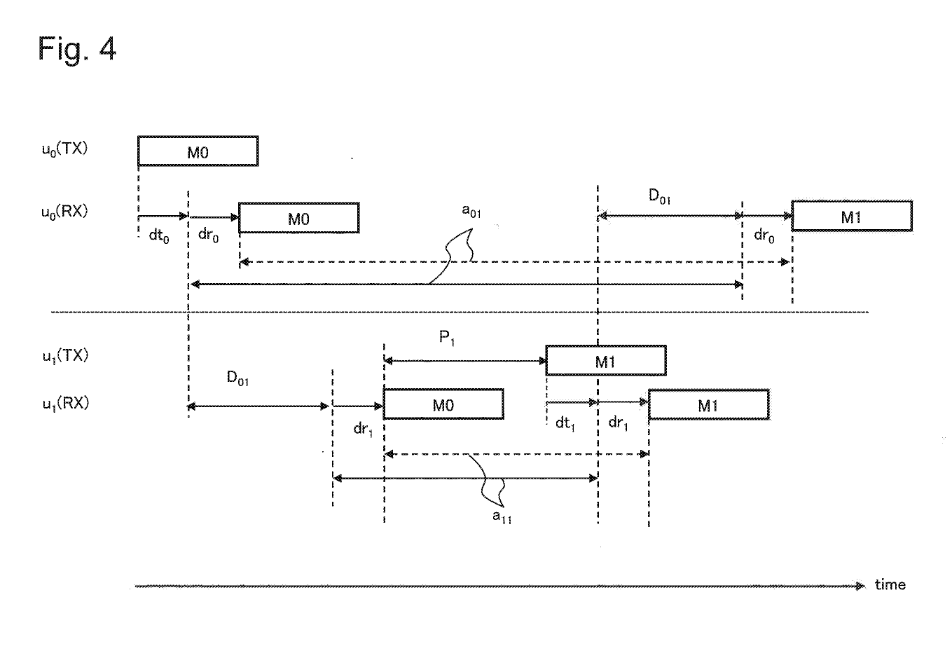

Next, a specific method will be described. FIG. 4 is a timing chart illustrating a transmission and reception operation of a timing pulse signal.

Following the denotation in FIG. 3, u(TX) and u(RX) in the drawing respectively denote a timing-pulse-signal transmission means and a timing-pulse-signal reception means, included in a control means 105.

First, the wireless device 0u₀ transmits a timing pulse signal M0 from u₀(TX). M0 is input to an RF-signal transmission means 101, and the RF-signal transmission means 101 outputs a timing pulse signal M0 as an RF signal, dt₀ after the input of M0. Next, in the wireless device 0u₀, M0 is input to an RF-signal reception means 102 by loopback, and u₀(RX) receives M0, dr₀ after the input. That is, M0 arrives at u₀(RX), dt₀+dr₀ after u₀(TX) transmits M0.

M0 also arrives at the wireless device 1u₁, taking a time D₀₁ for a radio wave to propagate between the wireless devices, after being transmitted by the RF-signal transmission means 101. In the wireless device u₁, the RF-signal reception means 102 receives M0, and u₁(RX) receives M0 after a delay time dr₁. That is, M0 arrives at u₁(RX) in the wireless device 1u₁, a delay time dt₀+D₀₁+dr₁ after transmission by u₀(TX).

Next, triggered by reception of M0, the wireless device u₁ generates and transmits a second-timing-pulse signal M1. A delay time between reception of M0 by u₁(RX) and transmission of M1 by u₁(TX) is herein denoted by P₁. Further, in the wireless device u₁, u₁(RX) receives M1, a delay time dt₁+dr₁ after transmission of M1 by loopback by u₁(TX).

M1 also propagates between the wireless devices, and therefore arrives at the wireless device 0u₀, taking a delay time D₀₁ after being transmitted by the RF-signal transmission means 101. In the wireless device u₀, u₀(RX) receives M1, a delay time dr₀ after reception of the signal by the RF reception means.

A difference between a reception time of M1 by u₀(RX) and a reception time of M0 by u₀(RX), in the wireless device u₀, is herein denoted by a₀₁. At this time, M0 and M1 are received by the same timing-pulse-signal reception means u₀(RX), and therefore a₀₁ takes a value independent of the delay time dr₀ required for passing through the RF-signal reception means 102. Further, a difference between a reception time of M1 by u₁(RX) and a reception time of M0 by u₁(RX), in the wireless device u₁, is herein denoted by a₁₁. Similarly to a₀₁, a₁₁ also takes a value independent of the delay time dr₁ for reception. The respective times are measured by the control unit 105.

Focusing solely on the wireless device u₀ side with reference to FIG. 4, a time between transmission of M0 by u₀(TX) and reception of M1 by u₀(RX) is dt₀+a₀₁+dr₀. Further, considering a route through the wireless device u₁, the same time between transmission of M0 by u₀(TX) and reception of M1 by u₀(RX) is dt₀+D₀₁+a₁₁+D₀₁+dr₀. In other words, the following equation holds.

d₀t+a₀₁+d₀r=d₀t+D₀₁+a₁₁+2D₀₁+d₀r . . .

As dt₀ and dr₀ on the left-hand side and the right-hand side of equation (1) are offset, the following equation is obtained.

$${a}_{01} = {a}_{11} + 2 {D}_{01} \\ ∴ {D}_{01} = \frac{{a}_{01} - {a}_{11}}{2} \qquad ( 3 )$$

From equation (3), a propagation time D₀₁ of a radio wave can be obtained as a value independent of the delay times (dt and dr) within the wireless device. Then, denoting the speed of light (radio wave) by c, and a distance between the wireless devices u₀ and u₁ by L₀₁, L₀₁ can be obtained from the following equation.

$${L}_{01} = c \cdot {D}_{01} = c \cdot \frac{{a}_{01} - {a}_{11}}{2} \qquad ( 4 )$$

In the equation above, a₀₁ is measured in the wireless device 0u₀, and a₁₁ is measured in the wireless device 1u₁. In other words, a₀₁ and a₁₁ are independent of one another, and therefore time synchronization between the two wireless devices u₀ and u₁ is not required.

As described above, the present exemplary embodiment is able to precisely estimate a distance between two wireless devices without requiring time synchronization between the wireless devices, and without being influenced by a delay time within the wireless device.

### Fifth Exemplary Embodiment

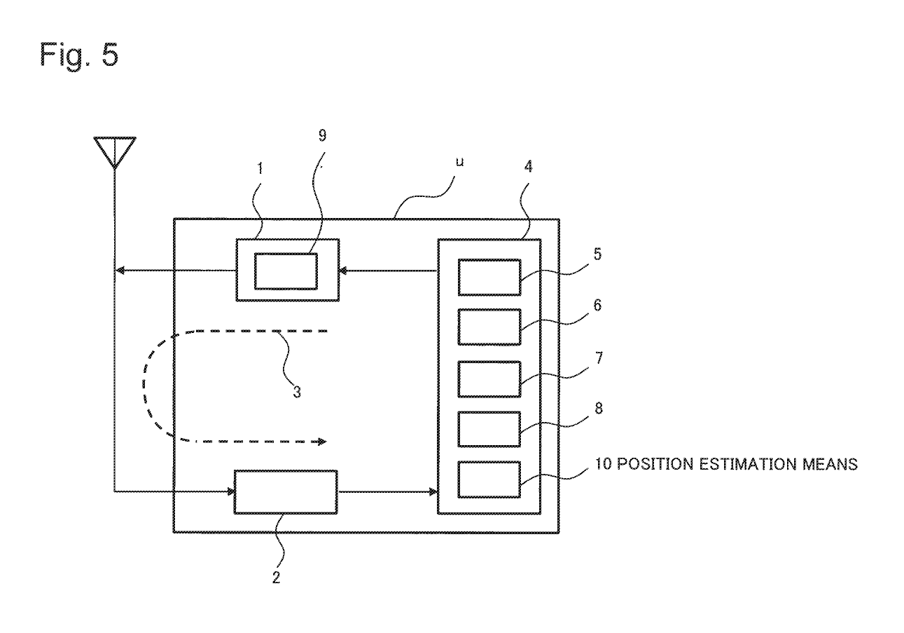

FIG. 5 is a block diagram illustrating a wireless device u used in the present exemplary embodiment. The wireless device u according to the present exemplary embodiment includes a position estimation means 10. As described in the fourth exemplary embodiment, a distance between wireless devices can be precisely obtained, by use of the wireless device according to the second exemplary embodiment. Accordingly, with three or more mutually separated wireless devices, a relative positional relation can be estimated by an operation, from distances between the respective wireless devices. The position estimation means 10 is a means for the estimation.

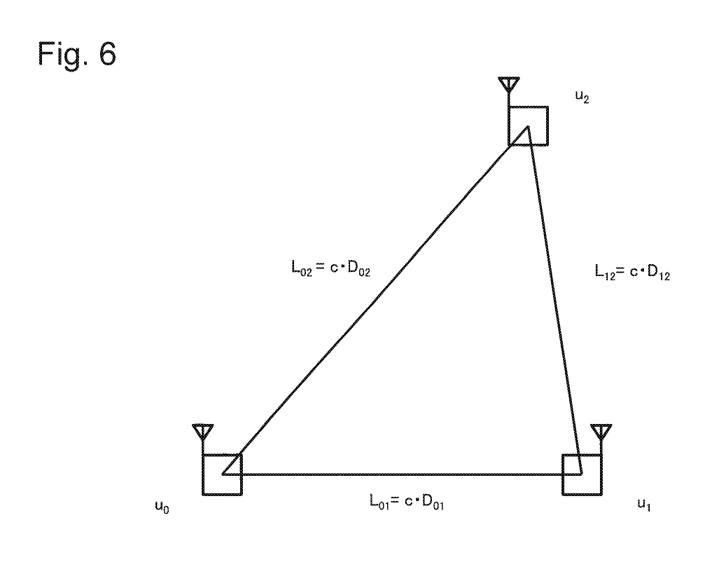

FIG. 6 is a schematic diagram illustrating a principle of position estimation. Three wireless devices u₀, u₁, and u₂ are positioned at mutually distant locations. Denoting a distance between u₀ and u₁ by Lₒᵢ, a distance between u₁ and u₂ by L₁₂, and a distance between u₀ and u₂ by L₀₂, the distances are obtained as products of respective propagation times D₀₁, D₁₂, and D₀₂ of a radio wave and the light speed c.

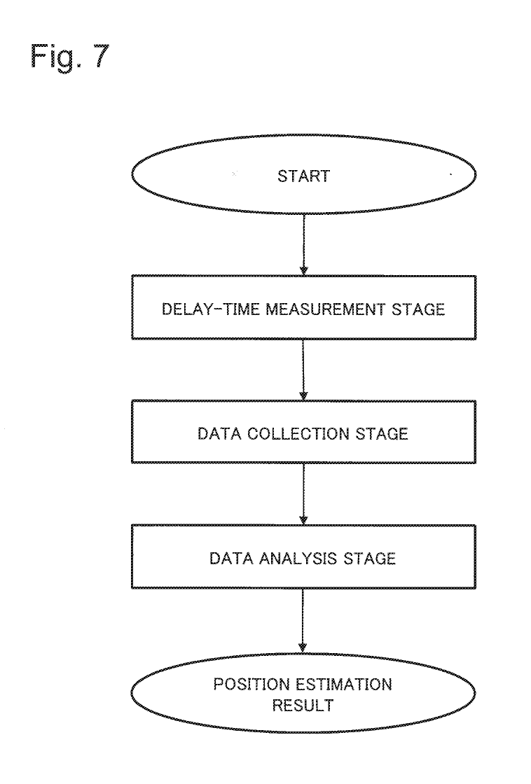

Next, an estimation method of a relative position will be described. As illustrated in FIG. 7, the position estimation is performed in three main stages: a delay-time measurement stage, a data collection stage, and a data analysis stage. In the delay-time measurement stage, timing pulse signals are successively transmitted from the respective wireless device u, and a time difference between the respective received timing pulse signals, that is, a delay time is measured. In the data collection stage, measured time difference data are collected at one wireless device such as u₀. In the data analysis stage, propagation times of radio waves between the respective wireless devices are calculated from collected time difference data, distances between the respective wireless devices are obtained from the propagation times, and a positional relation is estimated.

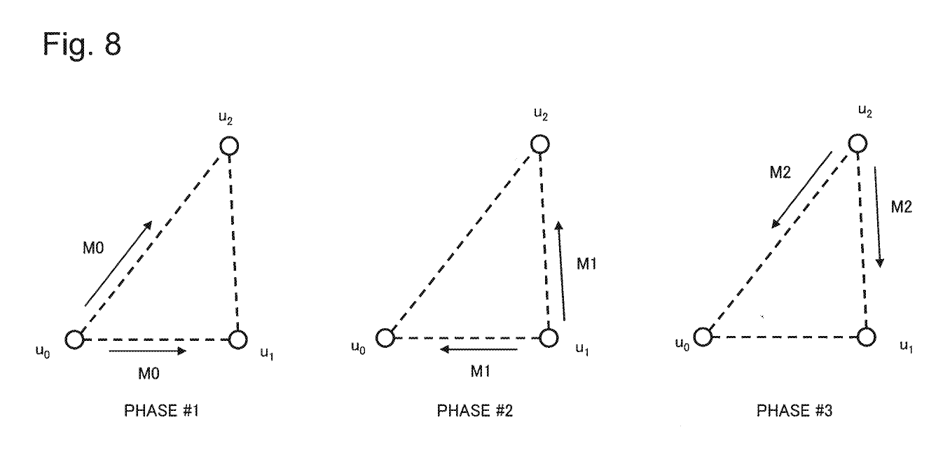

The delay-time measurement stage is divided into three phases illustrated in FIG. 8. In phase #1, a timing pulse signal M0 is transmitted from u₀ to u₁ and u₂, respectively. In phase #2, a timing pulse signal M0 is transmitted from u₁ to u₂ and u₀, respectively. In phase #3, a timing pulse signal M0 is transmitted from u₂ to u₀ and u₁, respectively. A rule is made in advance so that u₀ first transmits a timing pulse signal M0, u₁ transmits a timing pulse signal M1, triggered by reception of M0, and u₂ transmits a timing pulse signal M2, triggered by reception of M1.

At this time, in a wireless device on the receiving side, a source of each timing pulse signal needs to be identified. Accordingly, an identification means is added to a timing pulse signal, while any method thereof may be employed. For example, when a spread spectrum scheme is used, a source wireless device can be identified by using a different spread code for each wireless device.

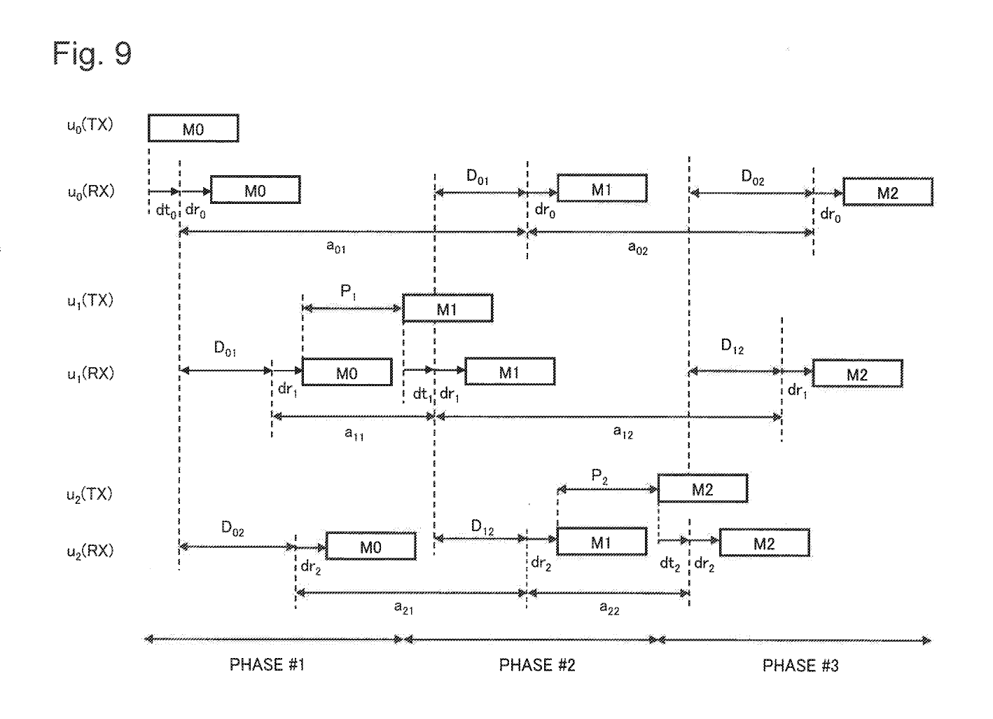

Next, details of an operation will be described. FIG. 9 is a timing chart illustrating a transmission and reception operation of a timing pulse signal in three wireless devices u₀, u₁, and u₂. Similarly to the fourth exemplary embodiment, a timing-pulse-signal transmission means in the wireless device u₀ is denoted by u₀(TX), a timing-pulse-signal reception means in the wireless device u₀ is denoted by u₀(RX), a timing-pulse-signal transmission means in u₁ is denoted by u₁(TX) Further, a first-timing-pulse signal is denoted by M0, a second-timing-pulse signal is denoted by M1, and a third-timing-pulse signal is denoted by M2.

(Phase #1) First, M0 is transmitted from the timing-pulse-signal transmission means u₀(TX) in the wireless device u₀.

Next, M0 is input to an RF-signal reception means in the wireless device u₀ after a delay time dt₀ for passing through an RF-signal transmission means, and arrives at u₀(RX) after a delay time dr₀. Further, M0 arrives at a timing-pulse-signal reception means u₁(RX) in the wireless device u₁ after a delay time D₀₁+dr₁, and arrives at a timing-pulse-signal reception means u₂(RX) in the wireless device u₂ after a delay time D₀₂+dr₂.

(Phase #2) In the wireless device u₁, a timing pulse signal M1 is generated, triggered by arrival of the timing pulse signal M0 at u₁(RX). A delay time between arrival of M0 at u₁(RX) and generation of M1 is herein denoted by P₁. M1 is transmitted from an RF-signal transmission means in the wireless device u₁ after a delay time dt₁.

M1 transmitted from the RF-signal transmission means in the wireless device u1 arrives at u₁(RX) by loopback after a delay time dr₁. Further, M1 arrives at u₂(RX) after a delay time D₁₂+dr₂, and arrives at u₀(RX) after a delay time D₀₁+dr₀.

(Phase #3) In the wireless device u₂, a timing pulse signal M2 is generated, triggered by arrival of the timing pulse signal M1 at u₂(RX). A delay time between reception of M1 and generation of M2, respectively by u₂(RX), is herein denoted by P₂. M2 is transmitted from an RF-signal transmission means after a delay time dt₂.

Subsequently, M2 arrives at u₂(RX) by loopback after a delay time dr₂ for passing through an RF-signal reception means. Further, M2 arrives at u₁(RX) after a delay time D₁₂+dr₁, and arrives at u₀(RX) after a delay time D₀₂+dr₀. Thus, the delay time measurement is completed.

Next, data collection is performed. In the data collection stage, respective measured delay times are transmitted to one wireless device u, such as u₀. Then, the data collection stage transitions to data analysis.

An estimation procedure of a relative position in the next data analysis stage will be described. In FIG. 9, a difference between an arrival time of M0 and an arrival time of M1, respectively at u₀(RX), is herein denoted by aₒₗ, and a difference between an arrival time of M1 and an arrival time of M2, respectively at u₀(RX), is denoted by a₀₂.

Similarly, a difference between an arrival time of M0 and an arrival time of M1, respectively at u₁(RX), is denoted by a₁₁, and a difference between an arrival time of M1 and an arrival time of M2, respectively at u₁(RX), is denoted by a₁₂.

Similarly, a difference between an arrival time of M0 and an arrival time of M1, respectively at u₂(RX), is denoted by a₂₁, and a difference between an arrival time of M1 and an arrival time of M2, respectively at u₂(RX), is denoted by a₂₂.

Then, the following three equations hold.

a₀₁=2D₀₁+a₁₁ . . .

a₁₂=2D₁₂+a₂₂ . . .

a₀₁+a₀₂=2D₀₂+a₂₁+a₂₂ . . .

a₀₁+a₀₂=2D₀₂+a₂₁+a₂₂ . . .

By use of the three equations and the light speed c, a distance between the respective wireless devices can be obtained. When a distance between u₀ and u₁ is denoted by L₀₁, a distance between u₁ and u₂ is denoted by L₁₂, and a distance between u₀ and u₂ is denoted by L₀₂, the distances between the respective wireless devices are obtained by the following equations.

$${L}_{01} = c \cdot {D}_{01} = c \cdot \frac{{a}_{01} - {a}_{11}}{2} \\ {L}_{12} = c \cdot {D}_{12} = c \cdot \frac{{a}_{12} - {a}_{22}}{2} … )$$

$${L}_{02} = c \cdot {D}_{02} = c \cdot \frac{{a}_{01} + {a}_{02} - {a}_{21} - {a}_{22}}{2}$$

The equations do not include the delay times (dr₀, dr₁, and dr₂) in the reception means 2 and the loopback delay times (dt₀, dt₁, and dt₂). Consequently, a time measurement error due to delay in a wireless device is not generated. Accordingly, a distance between the wireless devices can be measured with high precision. Furthermore, as illustrated in FIG. 6, a relative positional relation can be estimated from the respective distances between the three wireless devices.

Further, at this time, a₀₁ and a₀₂ are measured solely by the wireless device 0u₀, and measured independent of time measurement means in the wireless device 1u₁ and the wireless device 2u₂. Similarly, a₁₁ and a₁₂ are measured solely by the wireless device 1u₁, and a₂₁ and a₂₂ are measured solely by the wireless device 2u₂. Therefore, the present exemplary embodiment does not need time synchronization between wireless devices.

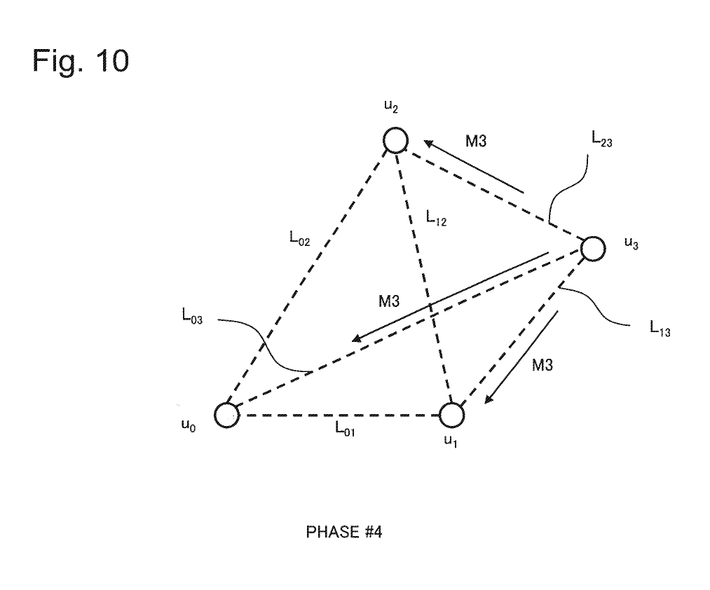

When there are four or more wireless devices u, a distance between the respective wireless devices can be measured and a relative position can be estimated by a similar procedure. FIG. 10 is a diagram illustrating a topology, adding a fourth wireless device 3u₃ to the topology composed of the aforementioned three wireless devices. The wireless device 3u₃ transmits a timing pulse signal M3, triggered by reception of a timing pulse signal M2 from the wireless device 2u₂ (phase #4). Then, a delay time until the timing pulse signal M3 is received by each wireless device u is measured, and collected at, for example, u₀, as delay time information. By use of the delay time information and the known delay time information, a distance L₀₃ between u₃ and u₀, a distance L₁₃ between u₃ and u₁, and a distance L₂₃ between u₃ and u₂ are respectively obtained. Consequently, relative positions between the four wireless devices can be estimated.

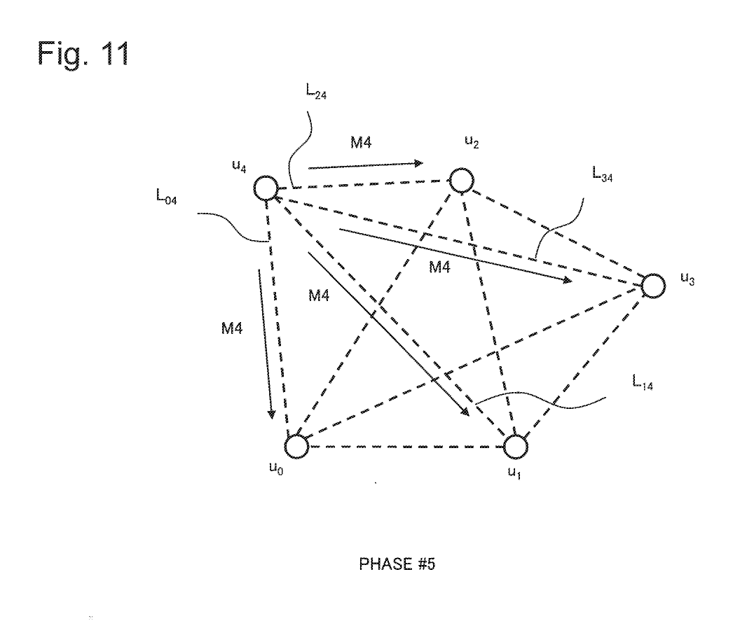

FIG. 11 is a diagram illustrating a topology, further adding a fifth wireless device u₄. The wireless device u₄ transmits a timing pulse signal M4, triggered by reception of a timing pulse signal M3 from the wireless device u₃ (phase #5). Then, a distance L₀₄ between u₄ and u₀, a distance L₁₄ between u₄ and u₁, a distance L₂₄ between u₄ and u₂, and a distance L₃₄ between u₄ and u₃ can be respectively obtained by a similar procedure to the aforementioned description. Consequently, relative positions between the five wireless devices can be estimated.

Similarly, when a sixth, seventh, . . . wireless device is added, a relative position of each wireless device u can be estimated.

As is obvious from the aforementioned description, with three or more wireless devices, a relative position between wireless devices can be precisely and rapidly estimated regardless of a quantity of wireless devices, by transmitting and receiving timing pulse signals M by a relay scheme.

### Sixth Exemplary Embodiment

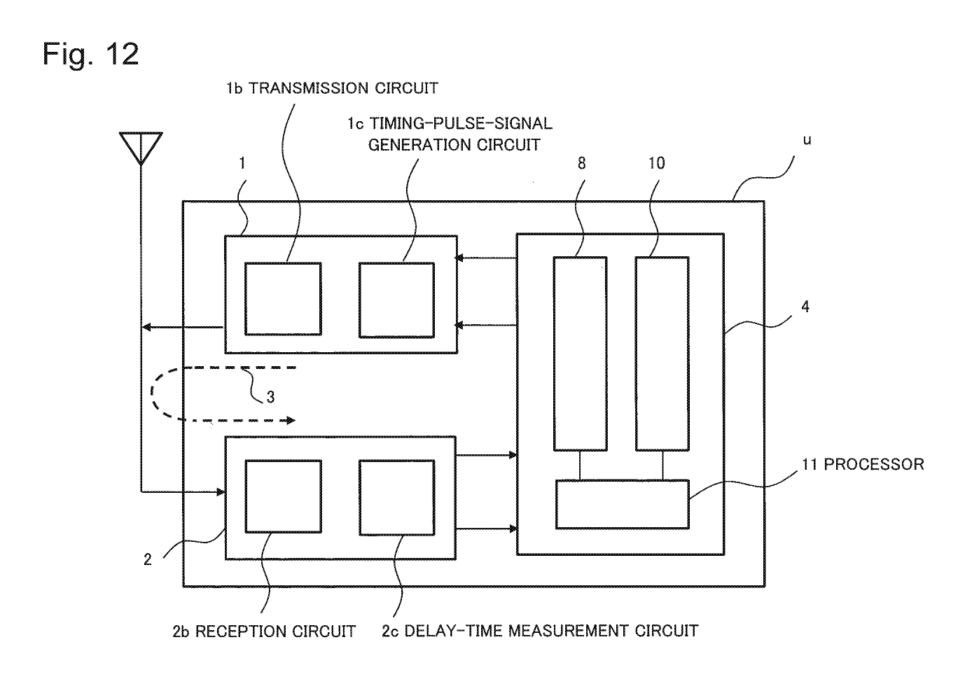

FIG. 12 is a block diagram illustrating a specific configuration example of a wireless device u. A timing-pulse-signal transmission means 1 includes a transmission circuit 1b and a timing-pulse-signal generation circuit 1c. A reception means 2 includes a reception circuit 2b and a delay-time measurement circuit 2c. Further, the timing-pulse-signal generation means 1 and the reception means 2 are controlled by a control means 4. The control means 4 includes a processor 11, and the processor 11 is connected to a distance estimation means 8 and a position estimation means 10 to perform various types of operation and control.

As described above, the present exemplary embodiment is able to provide a wireless device capable of precisely and rapidly estimating a relative position between wireless devices, similarly to the fifth exemplary embodiment.

### Seventh Exemplary Embodiment

The present exemplary embodiment illustrates examples of specific configurations for providing functions of respective units.

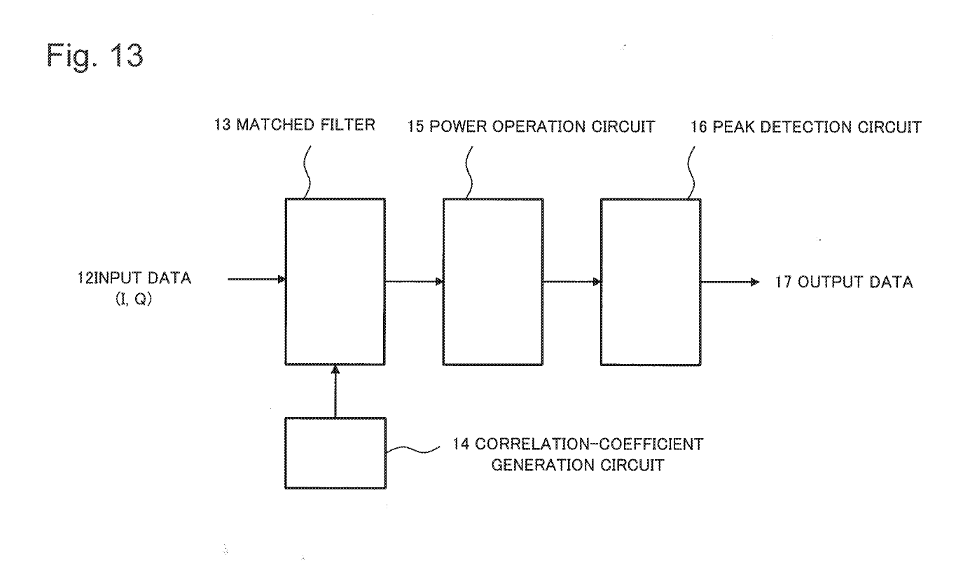

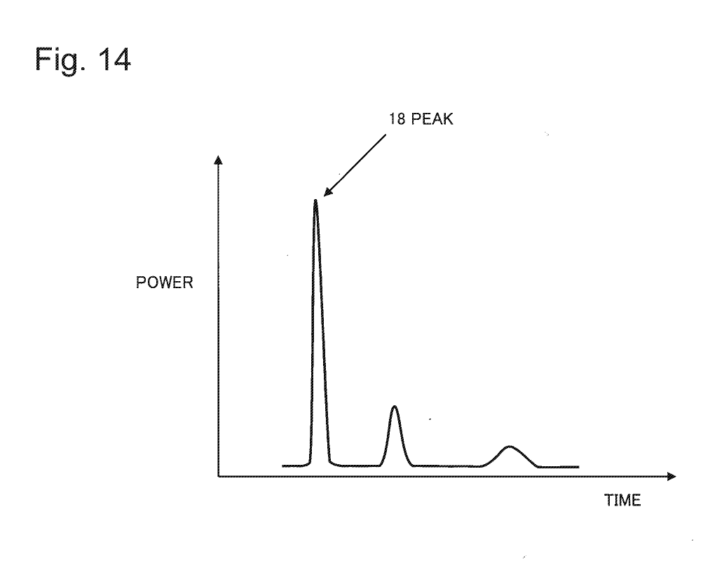

FIG. 13 is a block diagram illustrating a specific configuration example of a delay measurement circuit 2c. The configuration example illustrates a configuration using a spread-spectrum timing pulse signal using a spread code. A timing pulse signal converted into a baseband signal by a reception means 2 is referred to as input data 12. The input data 12 such as in-phase/quadrature-phase data (I/Q data) are input to a matched filter 13 as a vector value. At the same time, a correlation coefficient for a timing pulse signal is provided for the matched filter 13 by a correlation-coefficient generation circuit 14, and a cross-correlation vector value is calculated. The cross-correlation vector value is converted into power in a power operation circuit 15, and a power profile is generated. The power profile is a wave form having a peak value. A time at which the peak occurs is measured by use of a peak detection circuit 16. An arrival time of the timing pulse signal can be obtained from output data 17 of the peak detection circuit 16. The power profile has, for example, a wave form as illustrated in FIG. 14, and a climax indicating a maximum value in the diagram is detected as a peak 18.

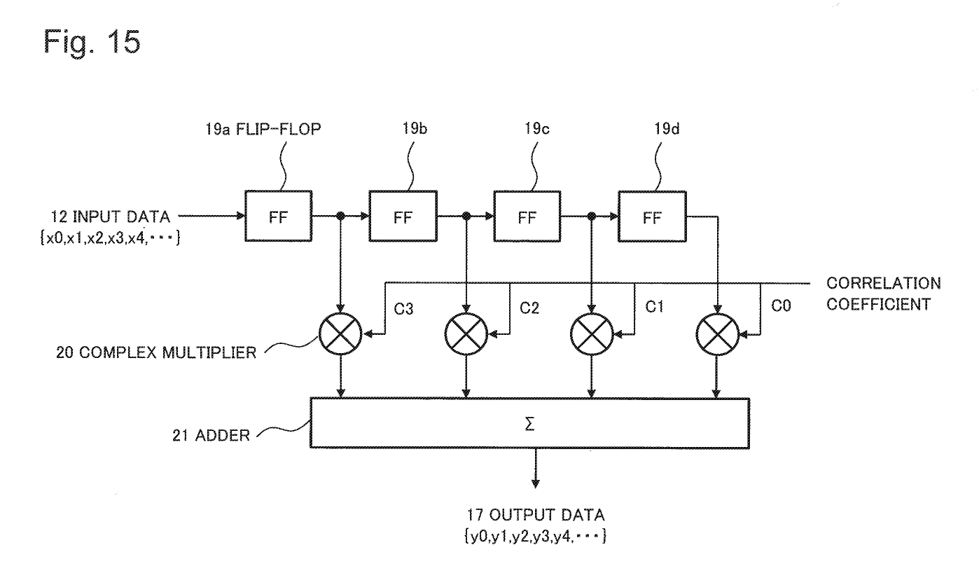

FIG. 15 illustrates a specific configuration example of the matched filter 13. A baseband signal of a timing pulse signal is input to the matched filter 13 as input data 12 (x0, x1, x2, . . . ). The input data 12 are latched by a plurality of flip-flops (FF) 19. Values latched by the respective flip-flops 19 and correlation coefficients C (C0, C1, C2, and C3) are multiplied by a complex multiplier 20, the sum of the products is calculated by an adder 21, and a cross-correlation vector is output as output data 17 (y0, y1, y2, . . . ).

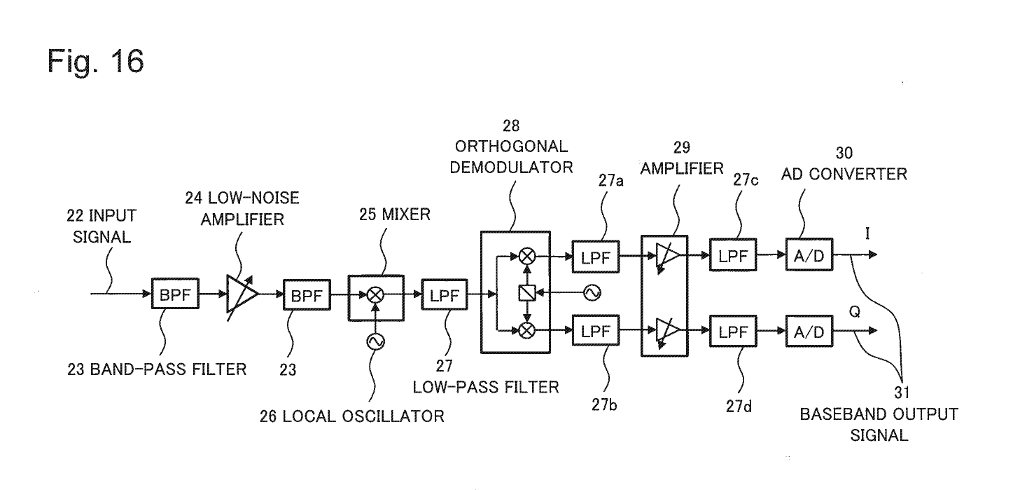

FIG. 16 is a block diagram illustrating a configuration example of a reception circuit 2b used in the reception means 2. The example is a superheterodyne RF circuit. First, an input signal 22 is input to a band-pass filter 23. A signal with a target frequency is selected by the band-pass filter 23, amplified by a low-noise amplifier 24, and passed to a band-pass filter 23 again. Next, the signal is multiplied by a high frequency of a local oscillator 26 by a mixer 25, and only a required downconverted signal is passed through a low-pass filter 27. Next, the signal is separated into an I component and a Q component by an orthogonal demodulator 28. Subsequently, low-pass filters 27a and 27b cut a high-frequency component from the respective signals, and an amplifier 29 amplifies the signals. Then, low-pass filters 27c and 27d shape the wave forms, and an analog-to-digital converter (AD converter) 30 converts the signals into digital signals to obtain baseband output signals 31 composed of an I component and a Q component.

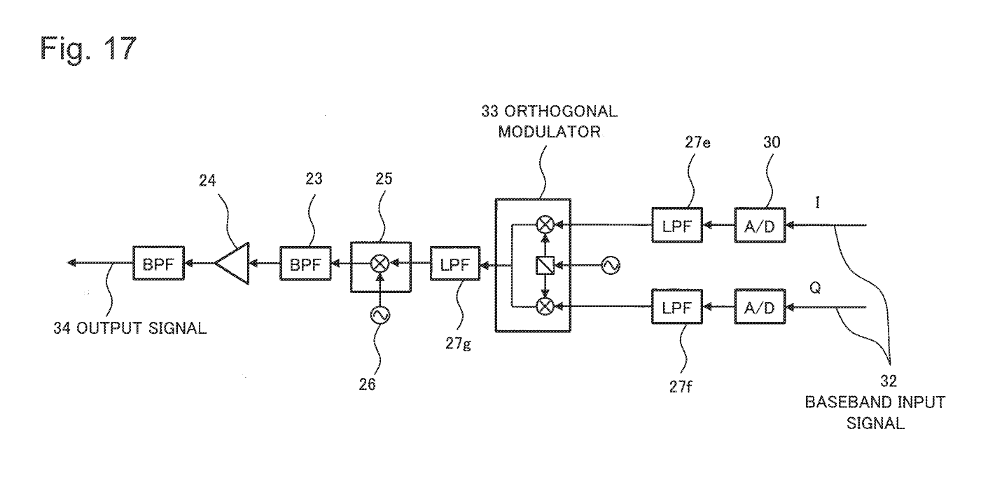

FIG. 17 is a block diagram illustrating a configuration example of a transmission circuit 1b. The example is a superheterodyne RF circuit. First, I-component and Q-component signals are respectively input to AD converters 30 as baseband input signals 32. The digital signals are converted into analog signals by the AD converter. The wave forms of the signals are shaped into a predetermined band by low-pass filters 27e and 27f, and subsequently the signals are modulated by an orthogonal modulator 33. Then, the wave form is shaped into a predetermined band by a low-pass filter 27g. Next, the signal is frequency-converted by a mixer 25, passes through a band-pass filter 23 passing only an upconverted transmission frequency, and is amplified by a low-noise amplifier 24. Next, a signal with the transmission frequency is selected from the amplified signal by a band-pass filter 23, and is output as an output signal 34.

As described above, the present exemplary embodiment is able to provide a wireless device precisely and rapidly estimating a relative position between wireless devices, similarly to the fifth and sixth exemplary embodiments.

The present invention has been described with the aforementioned exemplary embodiments as exemplary examples. However, the present invention is not limited to the aforementioned exemplary embodiments. In other words, various embodiments that can be understood by a person skilled in the art may be applied to the present invention, within the scope thereof.

This application claims priority based on Japanese Patent Application No. 2014-068137 filed on Mar. 28, 2014, the disclosure of which is hereby incorporated by reference thereto in its entirety.

### REFERENCE SIGNS LIST

1 Timing-pulse-signal transmission means
2 Reception means
3 Loopback path
4 Control means
5 Response-timing-pulse-signal transmission means
6 Delay-time measurement means
7 Delay-time transmission means
8 Distance estimation means
9 Identification-information assignment means
10 Position estimation means
11 Processor
12 Input data
13 Matched filter
14 Correlation-coefficient generation circuit
15 Power operation circuit
16 Peak detection circuit
17 Output data
18 Peak
19 Flip-flop
20 Complex multiplier
21 Adder
22 Input signal
23 Band-pass filter
24 Low-noise amplifier
25 Mixer
26 Local oscillator
27 Low-pass filter
28 Orthogonal demodulator
29 Amplifier
30 AD converter
31 Baseband output signal
32 Baseband input signal
33 Orthogonal modulator
34 Output signal
101 RF-signal transmission means
102 RF-signal reception means
103 Loopback path
104 Antenna
105 Control means
106 Timing-pulse-signal transmission means
107 Timing-pulse-signal reception means
108 Delay-time reception means
109 Distance estimation means
c Light speed
D Delay time
L Distance
M Timing pulse signal
u Wireless device

What is claimed is:

1. A wireless device comprising:
RF-signal transmission unit for transmitting an RF signal;
RF-signal reception unit for receiving an RF signal;
an antenna transmitting and receiving the RF signal;
a loopback path looping back an RF signal transmitted by the RF-signal transmissions unit to the RF-signal reception unit; and
control unit for exchanging a signal between the RF-signal transmission unit and the RF-signal reception unit,
the control unit comprising:
timing-pulse-signal transmission unit for transmitting a timing pulse signal to the RF-signal transmission unit;
timing-pulse-signal reception unit for receiving a timing pulse signal from the RF-signal reception unit;
delay-time reception unit for receiving, from a second wireless device transmitting a second-timing-pulse signal triggered by reception of a first-timing-pulse signal transmitted by the local device as a first wireless device, a delay time between reception of the first-timing-pulse signal and transmission of the second-timing-pulse signal, respectively by the second wireless device; and
distance estimation unit for estimating a distance between the local device and the second wireless device, in accordance with the first-timing-pulse signal, the second-timing-pulse signal, and the delay time.

2. The wireless device according to claim 1, further comprising
identification-information assignment unit for assigning identification information, distinguishing the second-timing-pulse signal from the first-timing-pulse signal, to the second-timing-pulse signal.

3. The wireless device according to claim 2, further comprising
position estimation unit for estimating, in accordance with a reception time of a third-timing-pulse signal transmitted by a third wireless device different from the first and second wireless devices, delay time information transmitted by the third wireless device, and a distance estimation result of the distance estimation unit, a relative positional relation between the first wireless device, the second wireless device, and the third wireless device.

4. A distance estimation system comprising a plurality of the wireless devices according to claim 1, wherein the plurality of the wireless devices mutually transmit and receive a timing pulse signal.

5. A position estimation system comprising at least three of the wireless devices according to claim 3, wherein the at least three of the wireless devices mutually transmit and receive a timing pulse signal.

6. A distance estimation method between wireless devices used in a wireless system composed of a plurality of wireless devices, the method comprising:
transmitting, by a first wireless device, a first-timing-pulse signal;
receiving, by the first wireless device, the first-timing-pulse signal by loopback;
receiving, by a second wireless device different from the first wireless device, the first-timing-pulse signal;
transmitting, by the second wireless device, a second-timing-pulse signal, triggered by reception of the first-timing-pulse signal;
measuring, by the second wireless device, a delay time between reception of the first-timing-pulse signal and transmission of the second-timing-pulse signal;
transmitting, by the second wireless device, the delay time;
receiving, by the first wireless device, the second-timing-pulse signal and the delay time; and
estimating, by the first wireless device, a distance between the first wireless device and the second wireless device, in accordance with the first-timing-pulse signal transmission and reception times, the second-timing-pulse signal reception time, and the delay time.

7. The distance estimation method according to claim 6, wherein
identification information distinguishing the second-timing-pulse signal from the first-timing-pulse signal is assigned to the second-timing-pulse signal.

8. A relative-position estimation method for a wireless device used in a wireless system composed of at least three wireless devices, the method comprising:
transmitting, by a first wireless device, a first-timing-pulse signal;
receiving, by the first wireless device, the first-timing-pulse signal by loopback;
receiving, by a second wireless device different from the first wireless device, the first-timing-pulse signal;
transmitting, by the second wireless device, a second-timing-pulse signal, triggered by reception of the first-timing-pulse signal;
measuring, by the second wireless device, a first delay time between reception of the first-timing-pulse signal and transmission of the second-timing-pulse signal;
transmitting, by the second wireless device, the first delay time;
receiving, by a third wireless device different from the first wireless device and the second wireless device, the second-timing-pulse signal;
transmitting, by the third wireless device, a third-timing-pulse signal, triggered by reception of the second-timing-pulse signal;
measuring, by the third wireless device, a second delay time between reception of the second-timing-pulse signal and transmission of the third-timing-pulse signal;
transmitting, by the third wireless device, the second delay time;
receiving, by the first wireless device, the second-timing-pulse signal, the first delay time, the third-timing-pulse signal, and the second delay time; and
estimating, by the first wireless device, a relative positional relation between the first wireless device, the second wireless device, and the third wireless device, in accordance with the first-timing-pulse signal transmission and reception times, the second-timing-pulse signal reception time, the first delay time, the third-timing-pulse signal reception time, and the second delay time.

9.-10. (canceled)
